(19) United States
(12) Patent Application Publication
(10) Pub. No.: US 2013/0239041 A1
(43) Pub. Date: Sep. 12, 2013

(54) GESTURE CONTROL TECHNIQUES FOR USE WITH DISPLAYED VIRTUAL KEYBOARDS

(71) Applicant: Behram Mario DaCosta, San Jose, CA (US)

(72) Inventor: Behram Mario DaCosta, San Jose, CA (US)

(73) Assignee: SONY CORPORATION, Tokyo (JP)

(21) Appl. No.: 13/413,061

(22) Filed: Mar. 6, 2012

(51) Int. Cl. G06F 3/048; G06F 3/033

(52) U.S. Cl. 715/773

(57) ABSTRACT

A gesture control technique includes receiving data indicating one or more of a presence, location, position, motion, and direction of a user finger or the like from a location interface, such as a camera, touch pad, gyroscope or the like. A graphical user interface including a virtual keyboard is displayed on a display. The presence, location, position, motion and direction data compared to a view space location of the virtual keyboard on the display to determine if the presence, location, position, motion and direction data is associated with location on the virtual keyboard. The presence, location, position, motion and direction data are displayed overlaid on the virtual keyboard, if the presence, location, position, motion and direction data is associated with the virtual keyboard. In addition, one or more gestures are determined from one or more sets of presence, location, position, motion and direction data. Furthermore, one or more alphanumeric or control inputs of the virtual keyboard are determined from the one or more gestures.

### BACKGROUND OF THE INVENTION

Electronic systems have made significant contributions toward the advancement of modern society and are utilized in a number of applications to achieve advantageous results. Numerous devices, such as computers, televisions, smart phones and the like have facilitated increased consumption of content, reduced costs in communicating content and the like in most areas of entertainment, education, business, and science. Electronic devices are increasingly receiving content from more and more sources. For example, televisions are now adapted to receive content from broadcast, cable, satellite, Internet, and the like sources.

One common aspect of electronic systems is the user interface. Most electronic systems include one or more user interfaces, such as control panels, remote control, keyboard, pointing device, and/or the like. Another user interface that is becoming common in electronic systems is the touch screen display. However, for electronic devices such as television in “lean-back” environments (e.g., living room, bedroom), the conventional control panel, keyboard, pointing device, touch screen display interfaces are disadvantageous. In addition, remote controls can be difficult to enter textual input with. Therefore, there is a continuing need for improved user interfaces for electronic devices.

### SUMMARY OF THE INVENTION

The present technology may best be understood by referring to the following description and accompanying drawings that are used to illustrate embodiments of the present technology directed toward gesture control techniques.

In one embodiment, a gesture control method includes receiving data indicating one or more of a presence, location, position, motion, and direction of a user gesturing member. A graphical user interface including a virtual keyboard is also displayed. The presence, location, position, motion and direction data is compared to the view space location of the virtual keyboard on the display, to determine if the presence, location, position, motion and direction data is associated with locations on virtual keyboard. One or more gestures are determined from one or more sets of presence, location, position, motion and direction data. The presence, location, position, motion and direction data is also displayed overlaid on the virtual keyboard, if the presence, location, position, motion and direction data is associated with the view space location of the virtual keyboard. Thereafter, one or more virtual keyboard alphanumeric or control inputs are determined from the one or more gestures.

The one or more alphanumeric or control inputs may be disambiguously determined from a layout of the virtual keyboard, a context, one or more previous alphanumeric or control inputs, one or more inputs from another source, one or more applications, one or more user preferences, one or more previous uses by a user, one or more data sets (e.g., interactive program guide, a spell check dictionary), one or more available menu choices and/or the like. The one or more alphanumeric or control inputs may be determined utilizing an autocomplete algorithm, a disambiguation algorithm, and/or the like.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Embodiments of the present technology are illustrated by way of example and not by way of limitation, in the figures of the accompanying drawings and in which like reference numerals refer to similar elements and in which:

FIG. 1 shows a block diagram of a system including a gesture controlled interface, in accordance with one embodiment of the present technology.

FIGS. 2A-2B show a flow diagram of a gesture input/control method, in accordance with one embodiment of the present technology.

FIGS. 3A-3B illustrate an exemplary gesture, in accordance with one embodiment of the present technology.

FIG. 4 illustrates a gesturing input technique, in accordance with one embodiment of the present technology.

### DETAILED DESCRIPTION OF THE INVENTION

Reference will now be made in detail to the embodiments of the present technology, examples of which are illustrated in the accompanying drawings. While the present technology will be described in conjunction with these embodiments, it will be understood that they are not intended to limit the invention to these embodiments. On the contrary, the invention is intended to cover alternatives, modifications and equivalents, which may be included within the scope of the invention as defined by the appended claims. Furthermore, in the following detailed description of the present technology, numerous specific details are set forth in order to provide a thorough understanding of the present technology. However, it is understood that the present technology may be practiced without these specific details. In other instances, well-known methods, procedures, components, and circuits have not been described in detail as not to unnecessarily obscure aspects of the present technology.

Some embodiments of the present technology which follow are presented in terms of routines, modules, logic blocks, and other symbolic representations of operations on data within one or more electronic devices. The descriptions and representations are the means used by those skilled in the art to most effectively convey the substance of their work to others skilled in the art. A routine, module, logic block and/or the like, is herein, and generally, conceived to be a self-consistent sequence of processes or instructions leading to a desired result. The processes are those including physical manipulations of physical quantities. Usually, though not necessarily, these physical manipulations take the form of electric or magnetic signals capable of being stored, transferred, compared and otherwise manipulated in an electronic device. For reasons of convenience, and with reference to common usage, these signals are referred to as data, bits, values, elements, symbols, characters, terms, numbers, strings, and/or the like with reference to embodiments of the present technology.

It should be borne in mind, however, that all of these terms are to be interpreted as referencing physical manipulations and quantities and are merely convenient labels and are to be interpreted further in view of terms commonly used in the art. Unless specifically stated otherwise as apparent from the following discussion, it is understood that through discussions of the present technology, discussions utilizing the terms such as “receiving,” and/or the like, refer to the actions and processes of an electronic device such as an electronic computing device that manipulates and transforms data. The data is represented as physical (e.g., electronic) quantities within the electronic device's logic circuits, registers, memories and/or the like, and is transformed into other data similarly represented as physical quantities within the electronic device.

In this application, the use of the disjunctive is intended to include the conjunctive. The use of definite or indefinite articles is not intended to indicate cardinality. In particular, a reference to “the” object or “a” object is intended to denote also one of a possible plurality of such objects. It is also to be understood that the phraseology and terminology used herein is for the purpose of description and should not be regarded as limiting.

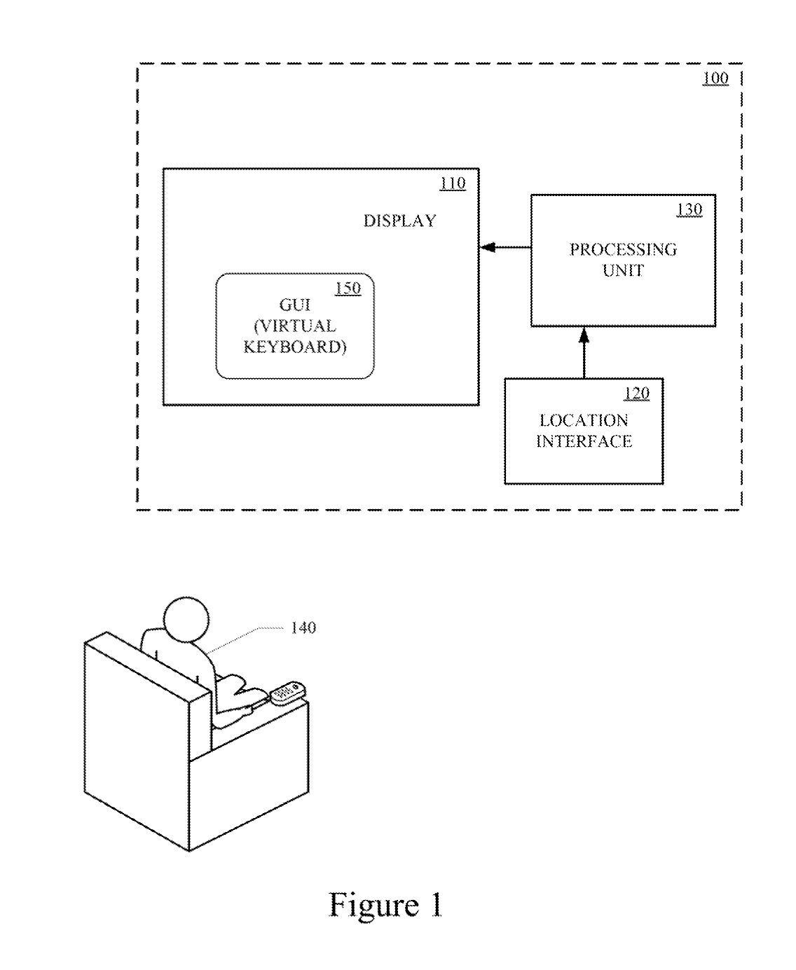

Referring to FIG. 1, a system including a gesture controlled interface, in accordance with one embodiment of the present technology, is shown. The system 100 includes a display 110 and presence, location, position, motion, direction and/or the like data input interface 120 communicatively coupled to a processing unit 130. The system 100 may also include one or more sub-systems, and/or may be coupled to one or more other systems, device and the like. The input interface enabled to receive presence, location, position, motion, direction and/or the like data is herein after referred to as the location interface 120 for simplicity. However, it is appreciated that the location interface 120 is adapted to receive data concerning a presence, location, position, motion, direction and/or the like. It is appreciated that in one implementation, the processing unit 130 and position interface 120 may be integral to the display (e.g., television) 110. In another implementation, the processing unit 130 may be integral to the display 110 and the position interface 120 may be an external peripheral or integral to another peripheral such as a television remote control, smart phone or the like. In yet another implementation, the processing unit 130 and/or position interface 120 may be integral to other devices such as satellite television receiver, cable television set top box, audio/video amplifier, optical disk player (e.g., Blue-Ray player), and/or the like. The above described implementations are just some of the many ways of implementing embodiments of the present technology, and are not intended to be limiting in anyway.

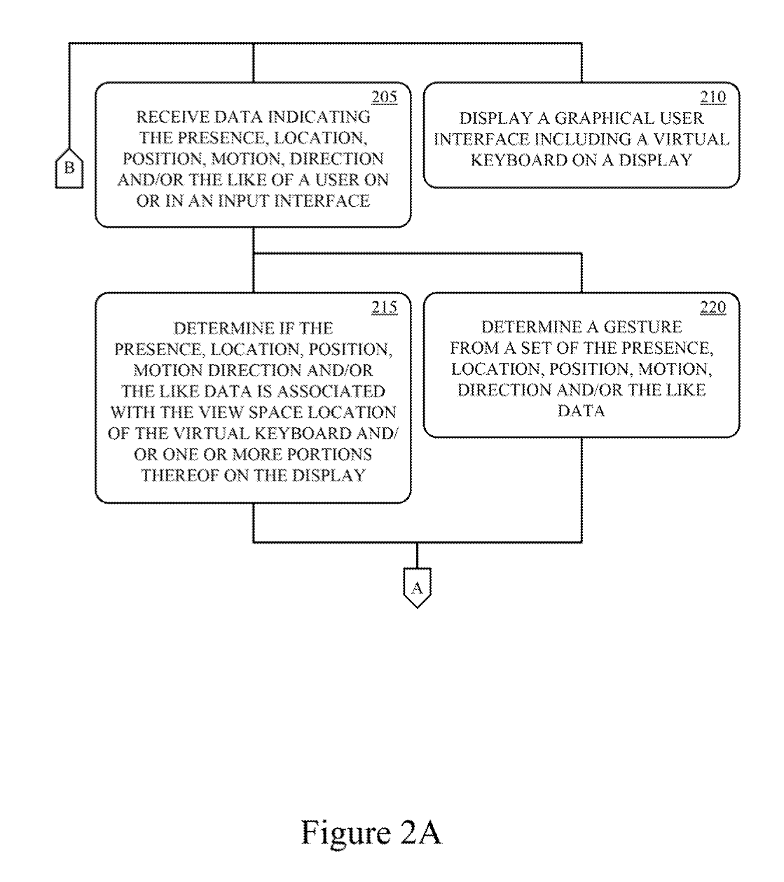

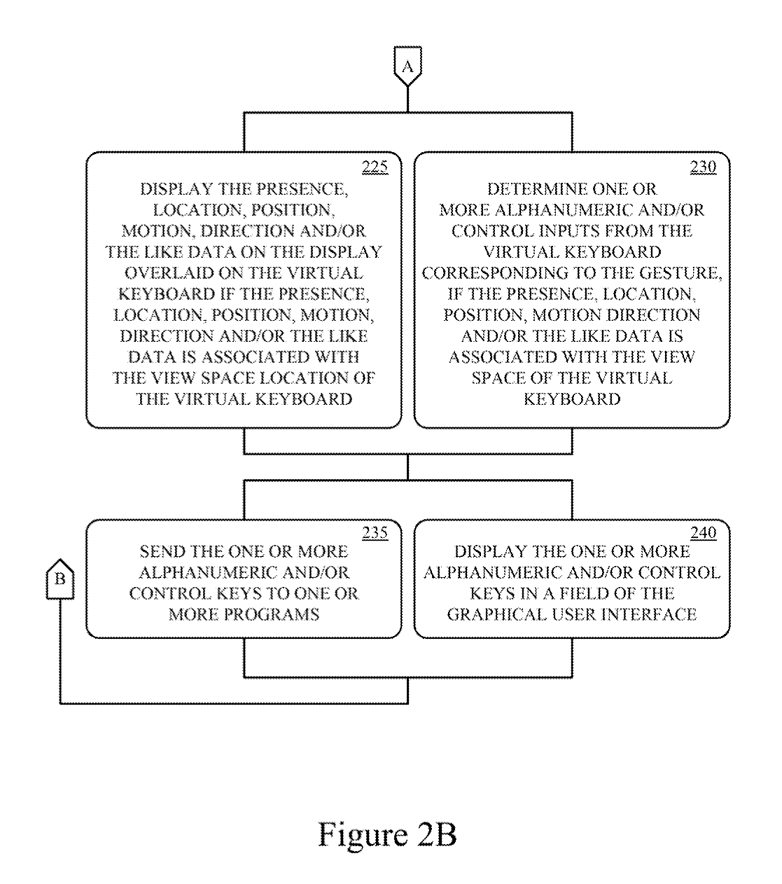

Operation of the system 100 will be further explained with reference to FIGS. 2A-2B, which shows a gesture input/control method in accordance with one embodiment of the present technology. The method may be implemented as computing device-executable instructions (e.g., software) that are stored in computing device-readable media (e.g., memory) and executed by a computing device (e.g., processor). The method may also be implemented in firmware, hardware or a combination of software, firmware, and/or hardware.

The gesture input/control method includes receiving data indicating presence, location, position, motion, direction and/or the like of a user gesturing member 140 on or in a location interface 120, at 205. The user gesturing member 140 may be an extended finger of a user, a hand of a user, or similar part. In one implementation, the location interface 120 may be a touch pad of a television remote control. The touch pad captures the presence, location, position, motion, direction and/or the like of a user's finger or a stylus. In another implementation, the presence, location, position, motion, direction and/or the like data is captured by a touch screen of a remote control, smart phone or the like. The touch screen includes a touch sensitive panel overlaying a display panel, wherein the touch sensitive panel captures the presence, location, position, motion, direction and/or the like of a user's finger or stylus. In yet another implementation, the presence, location, position, motion, direction and/or the like is captured by an accelerometer, gyroscope and/or the like of a remote control, smart phone or the like. In another implementation, the presence, location, position, motion, direction and/or the like is captured by a camera, 3D camera or stereoscopic camera. The above described implementations are just some of the many ways of implementing the location interface 120, and are not intended to be limiting in anyway. Furthermore, for position interfaces that include a touch screen for use in receiving presence, location, position, motion, direction and/or the like, it is appreciated that the touch screen is being utilized for receiving the input data and is considered a secondary device, while the display that displays the graphical user interface including the virtual keyboard and gestures overlaid thereon is the primary display.

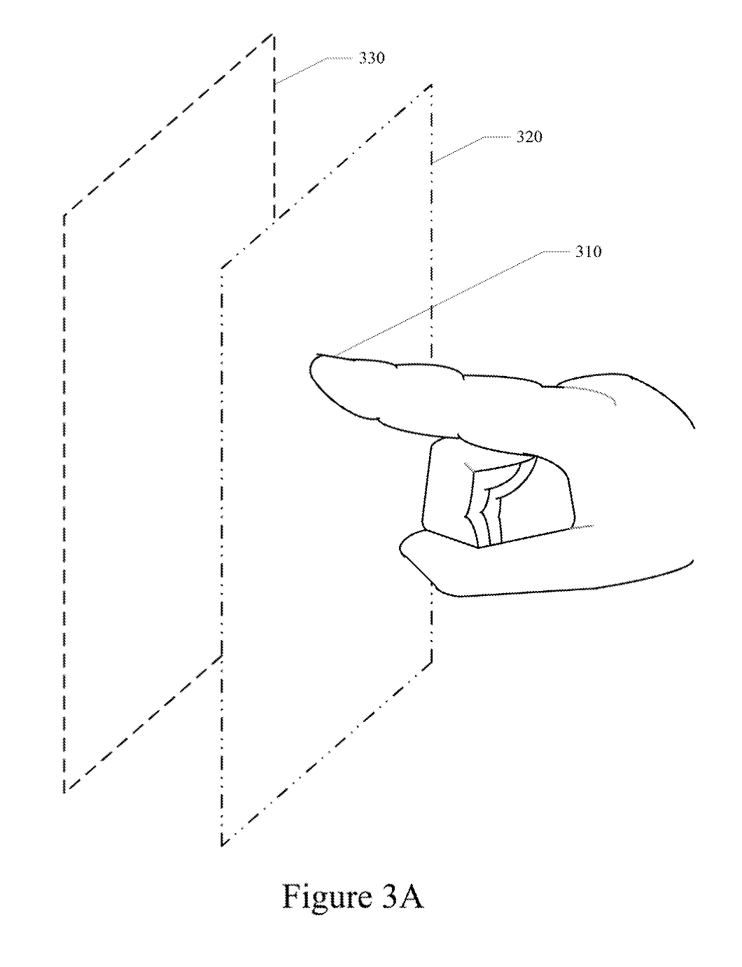

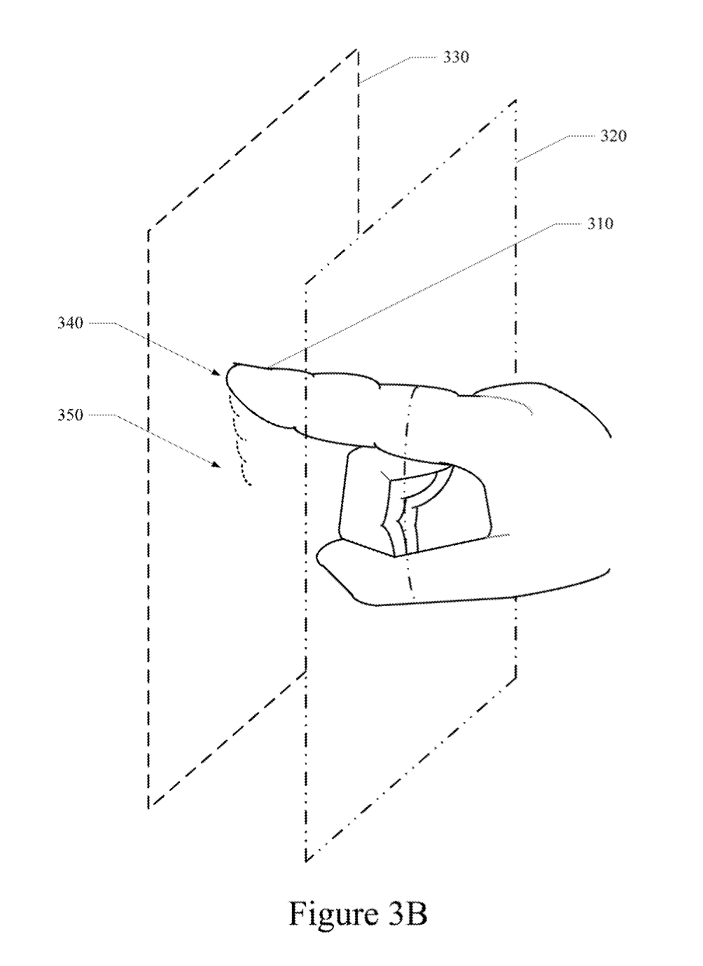

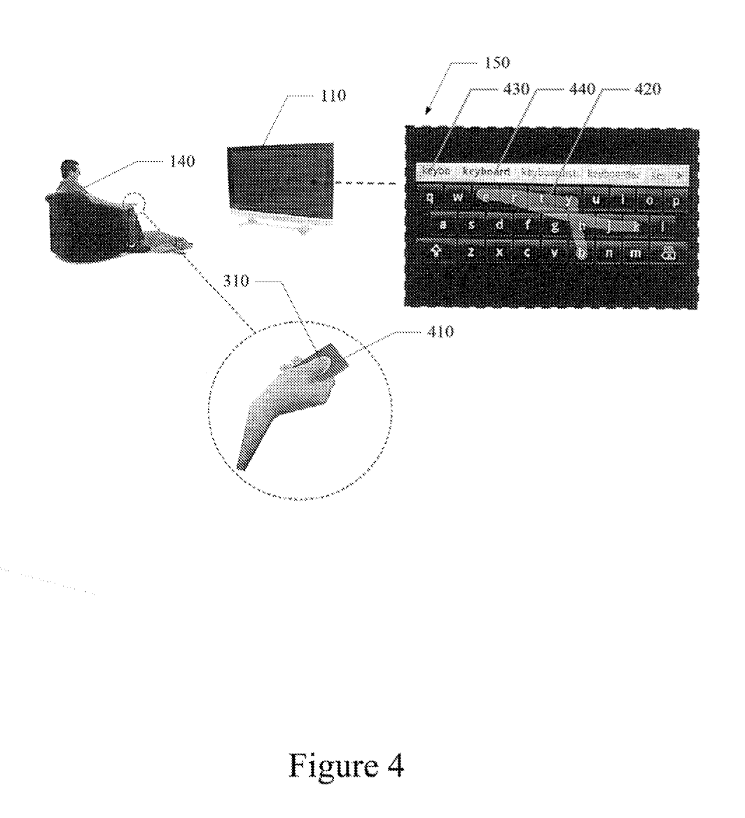

In an exemplary system, a camera (not shown) may capture the presence, location, position, motion, direction and/or the like of a user's finger 310 as illustrated in FIGS. 3A and 3B. When the user's finger 310 is not between a first and second plane 320, 330, the presence, location, position, motion, direction and/or the like of the finger 310 is ignored. When the user's finger 310 is between the first and second plane, the presence, location, position, motion, direction and/or the like of the finger 310 is received as corresponding input data by the camera. For instance, the movement of the user's finger from a first location 340 to a second location 350 may be received as corresponding presence, location, position, motion, direction and/or the like data. Alternatively, the presence, location, position, motion, direction and/or the like of a user's hand may be captured by a gyroscope in a remote control, smart phone or the like that is held by the user. In another example, a touch sensitive pad 410 of a remote control may capture the presence, location, position, motion, direction and/or the like of the user's finger 310 as corresponding input data while the user is watching the graphical user interface 150 on the display 110, as illustrated in FIG. 4. The touch sensitive pad 410 may have a virtual keyboard shown on it as well, to assist the user further, or the pad may be blank. In the latter case, the user gestures one the touch pad while watching the display.

At 210, a graphical user interface (GUI) including a virtual keyboard 150 is displayed on the display 110. In one implementation, the processing unit 130 generates image data of a graphical user interface including the virtual keyboard and outputs the image data to the display 110 for display. The virtual keyboard may be displayed in response to receipt of the presence, location, position, motion, direction and/or the like data on the input interface 120, some other input from the processing unit 130 (e.g., application), some other input/output interface of the system 100, or the like.

At 215, the presence, location, position, motion, direction and/or the like data is compared to the view space location of the virtual keyboard to determine if the data is associated with the virtual keyboard and/or one or more portions of the keyboard. In one implementation, the processing unit 130 determines if the presence, location, position, motion, direction and/or the like data is associated with the view space location of the virtual keyboard on the display. If the presence, location, position, motion, direction and/or the like data is associated with the view space location of the virtual keyboard, the processing unit may also determine which of one or more keys the presence, location, position, motion, direction and/or the like data is associated with.

At 220, one or more gestures are determined from a set of the presence, location, position, motion, direction and/or the like data. In one implementation, the processing unit 130 determines a gesture from the set of presence, location, position, motion, direction and/or the like data received from the location interface 120. In one implementation, one or more presence, location, position, motion or direction values may be used to identify sets of the presence, location, position, motion, direction and/or the like data for determining gestures. The gestures may also be determined based upon the association of the presence, location, position, motion, direction and/or the like data with one or more key of the virtual keyboard. The gestures may also be determined based upon a context, one or more previous gestures, one or more previous alphanumeric and/or control inputs determined from one or more previous gestures, one or more inputs from other sources, one or more applications, one or more data sets (e.g., interactive program guide, spell check dictionary), and/or the like. For example, a change of direction relative to the position of a key of the virtual keyboard may indicate that the data values before the change of direction are in a first set and correspond to a first gesture and the data values after are in a second set and correspond to a second gesture. In another example, a pause for at least a predetermined period of time at a location may similarly indicate different sets and/or different gestures. In yet another example, change of locations from substantially within a first plane to locations substantially in a second plane transverse to the first plane and then back to locations substantially within the first plane (for example, simulating actuation of a given key of the keyboard) may similarly indicate different sets and/or different gestures.

For example, the change of direction at the corresponding location of ‘e’ key, and then at the ‘y’ key may be interpreted as a given gesture, as illustrated in FIG. 4. Disambiguation techniques may be employed to determine the given gesture.

At 225, the presence, location, position, motion, direction and/or the like data is displayed on the display as an overlay on the virtual keyboard if the presence, location, position, motion, direction and/or the like data corresponds to the view space location of the virtual keyboard. In one implementation, the processing unit 130 generates image data of the virtual keyboard with the gesture overlaid one or more corresponding portions of the virtual keyboard. The presence, location, position, motion, direction and/or the like data outside the view space of the virtual keyboard may also be displayed. For example, the presence, location, position, motion, direction and/or the like data corresponding to the view space of the virtual keyboard may be displayed in a first format (e.g., color) and the presence, location, position, motion, direction and/or the like data outside the view space of the virtual keyboard may be displayed in a second format.

For example, the presence, location, position, motion, direction and/or the like data is displayed on the display as an overlay as a highlighting 420 on the virtual keyboard, as illustrated in FIG. 4. In another example, the presence, location, position, motion, direction and/or the like data that is not between a predetermined first and second plane is overlaid in another highlight color. Similarly, presence, location, position, motion, direction and/or the like data that does not correspond to the view space of the virtual keyboard may be overlaid on the other corresponding portions of the graphical user interface in yet another highlight color.

At 230, one or more corresponding alphanumeric and/or control inputs from the virtual keyboard may be determined from the one or more gesture, if the presence, location, position, motion, direction and/or the like data corresponds to one or more portions (e.g., keys) of the virtual keyboard on the display. In one implementation, the processing unit 130 determines if the gesture indicates actuation (e.g., user selection) of one or more alphanumeric or control keys of the virtual keyboard. The one or more alphanumeric and/or control inputs may also be determined based upon the layout of the virtual keyboard, a context, one or more previous alphanumeric and/or control inputs, one or more inputs from other sources, one or more applicable applications, user preferences, previous use by user, one or more data sets (e.g., interactive program guide, spell check dictionary), and/or the like. For example, one or more letters may be determined based upon one or more previously determined letters utilizing an autocomplete algorithm. In another example, one or more alphanumeric and/or control inputs may be determined based one or more previously determined alphanumeric and/or control inputs and available choices of a menu. In yet another example, one or more alphanumeric and/or control inputs may be determined based upon one or more previously determined letters, a data set of an interactive program guide, a spell check dictionary, and/or the like.

For example, a gesture, determined from the change of direction at the corresponding location of the ‘e’ key, and then at the ‘y’ key, may be interpreted as one or more alphanumeric and/or control inputs such as the selection of the ‘e’ key and then the ‘y’ key of the virtual keyboard in the graphical user interface 150, as illustrated in FIG. 4. The next gesture, determined from the change of direction at the corresponding location of the ‘y’ and then on to the ‘b’ key may interpreted as selection of the ‘b’ key. In addition, previous determination of the selection of the keys ‘keyb’ may further be interpreted using an autocomplete algorithm to indicate the further selection of the ‘oard’ keys on the virtual keyboard of the graphical user interface 150. Various word-wise disambiguation techniques may be employed to determine the given which key are being selected by the user. Accordingly, one or more actual and/or predicted alphanumeric and/or control inputs can be determined from the gestures.

At 235, the one or more determined alphanumeric and/or control keys may be input to one or more programs (e.g., operating system, user application, utility, routine, and driver). In one implementation, the one or more gesture selected alphanumeric and/or control keys are provided by the processing unit to one or more programs executing on the processor and or another computing device. The one or more alphanumeric and/or control keys may also be displayed in an input field of the graphical user interface, at 240. For example, the determined alphanumeric key inputs of ‘keybo’ may be displayed in an input field 430 of the graphical user interface 150, as illustrated in FIG. 4. Furthermore, the determined alphanumeric key inputs of ‘keybo’ may be further interpreted by an autocomplete algorithm to indicate the input of ‘keyboard’ which may be displayed in a suggestion field 440 of the graphical user interface 150. A user may select an alternative intended alphanumeric and/or control key string from one or more options in the suggestion field 440 or other associated field of the graphical user interface. The processes of 205-240 are repeated to detect each of one or more gestures.

Embodiments of the present technology advantageously enable input using gestures on devices including displays, such as large televisions. A user can advantageously enter text using gestures on a secondary device or in space (e.g., air). The embodiments can be advantageously utilized with systems that are not intended for use with conventional physical keyboards, pointing devices, and/or touch screen displays. For example, embodiments may advantageously be employed in ‘lean-back’ viewing environments such as living rooms and bedrooms, or for passive viewing.

The foregoing descriptions of specific embodiments of the present technology have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is intended that the scope of the invention be defined by the claims appended hereto and their equivalents.

What is claimed is:

1. A method comprising:
receiving, by a location interface, data indicating one or more of a presence, location, position, motion, and direction of a user gesturing member;
displaying a graphical user interface including a virtual keyboard on a display;
determining, by a processing unit, if the presence, location, position, motion and direction data is associated with a view space location of the virtual keyboard on the display;
determining, by the processing unit, one or more gestures from one or more sets of presence, location, position, motion and direction data;
displaying the presence, location, position, motion and direction data on the display overlaid on the virtual keyboard, if the presence, location, position, motion and direction data is associated with the view space location of the virtual keyboard; and
determining, by the processing unit, one or more alphanumeric or control inputs from the virtual keyboard corresponding to the one or more gestures.

2. The method according to claim 1, further comprising sending, by the processing unit, the one or more alphanumeric or control keys to one or more programs.

3. The method according to claim 1, further comprising displaying the one or more alphanumeric or control keys in an input field of the graphical user interface on the display.

4. The method according to claim 1, wherein the presence, location, position, motion and direction data is displayed in a first format on the display, if the presence, location, position, motion and direction data is associated with the view space location of the virtual keyboard.

5. The method according to claim 4, further comprising displaying the presence, location, position, motion and direction data on the display in a second format overlaid on another corresponding portion of the graphical user interface, if the presence, location, position, motion and direction data is not associated with the view space location of the virtual keyboard.

6. The method according to claim 1, wherein the location interface for receiving the data indicating one or more of a presence, location, position, motion, and direction of a user gesturing member comprises a camera.

7. The method according to claim 1, wherein the location interface for receiving the data indicating one or more of a presence, location, position, motion, and direction of a user gesturing member comprises a touch pad.

8. The method according to claim 1, wherein the location interface for receiving the data indicating one or more of a presence, location, position, motion, and direction of a user gesturing member comprises a gyroscope or accelerometer of a television remote control or smart phone.

9. The method according to claim 1, wherein the one or more gestures are further determined, by the processing unit, from a context, one or more previous gestures, one or more input from another source, one or more applications, or one or more data sets.

10. The method according to claim 1, wherein the one or more alphanumeric or control inputs are further determined, by the processing unit, from one or more of a layout of the virtual keyboard, a context, one or more previous alphanumeric or control inputs, one or more inputs from another source, one or more applications, one or more user preferences, one or more previous uses, one or more data sets, an interactive program guide, a spell check dictionary, one or more available menu choices, an autocomplete algorithm, or a disambiguation algorithm.

11. A system comprising:
a means for receiving data indicating one or more of a presence, location, position, motion, and direction of a user gesturing member;
a means for displaying a graphical user interface including a virtual keyboard;
a means for determining if the presence, location, position, motion and direction data is associated with a view space location of the virtual keyboard on the display;
a means for determining one or more gestures from one or more sets of presence, location, position, motion and direction data;
a means for displaying the presence, location, position, motion and direction data on the display overlaid on the virtual keyboard, if the presence, location, position, motion and direction data is associated with the view space location of the virtual keyboard;
a means for disambiguously determining one or more alphanumeric or control inputs from the virtual keyboard corresponding to the one or more gestures; and
a means for displaying the one or more alphanumeric or control keys in an input field of the graphical user interface.

12. The system of claim 11, wherein the presence, location, position, motion and direction data is displayed in a first format, if the presence, location, position, motion and direction data is associated with the view space location of the virtual keyboard.

13. The system of claim 12, further comprising displaying the presence, location, position, motion and direction data in a second format overlaid on another corresponding portion of the graphical user interface, if the presence, location, position, motion and direction data is not associated with the view space location of the virtual keyboard.

14. The system of claim 11, wherein the means for receiving data indicating one or more of a presence, location, position, motion, and direction of a user gesturing member is received relative to a first and second plane in space.

15. One or more computing device readable media including computing device executable instructions that when executed by a processing unit implement a gesture control process comprising:
receiving data indicating one or more of a presence, location, position, motion, and direction of a user gesturing member from a location interface;
displaying a graphical user interface including a virtual keyboard on a display;
determining if the presence, location, position, motion and direction data is associated with a view space location of the virtual keyboard on the display;
determining one or more gestures from one or more sets of presence, location, position, motion and direction data;
displaying the presence, location, position, motion and direction data on the display overlaid on the virtual keyboard, if the presence, location, position, motion and direction data is associated with the view space location of the virtual keyboard; and
determining one or more alphanumeric or control inputs from the virtual keyboard corresponding to the one or more gestures.

16. The one or more computing device readable media including computing device executable instructions that when executed by the processing unit implement the gesture control process according to claim 15, further comprising sending the one or more alphanumeric or control keys to one or more programs.

17. The one or more computing device readable media including computing device executable instructions that when executed by the processing unit implement the gesture control process according to claim 15, further comprising displaying the one or more alphanumeric or control keys in an input field of the graphical user interface.

18. The one or more computing device readable media including computing device executable instructions that when executed by the processing unit implement the gesture control process according to claim 15, wherein the one or more gestures are disambiguously determined from one or more of a context, one or more previous gestures, a layout of the virtual keyboard, one or more input from another source, one or more applications, or one or more data sets.

19. The one or more computing device readable media including computing device executable instructions that when executed by the processing unit implement the gesture control process according to claim 15, wherein the one or more alphanumeric or control inputs are disambiguously determined from one or more of a layout of the virtual keyboard, a context, one or more previous alphanumeric or control inputs, one or more inputs from another source, one or more applications, one or more user preferences, one or more previous uses, one or more data sets, an interactive program guide, a spell check dictionary, one or more available menu choices.

20. The one or more computing device readable media including computing device executable instructions that when executed by the processing unit implement the gesture control process according to claim 15, wherein the presence, location, position, motion and direction data of the user gesturing member is optically received relative to a first and second plane in space.
